(19) United States
(12) Patent Application Publication
(10) Pub. No.: US 2011/0305867 A1
(43) Pub. Date: Dec. 15, 2011

(54) OUTDOOR RECREATIONAL COVERING APPARATUS WITH INTERNAL WEIGHTING SYSTEM

(76) Inventors: Jason Rex Lee, Newnan, GA (US); Michelle Denise Lee, Newnan, GA (US)

(21) Appl. No.: 12/815,895

(22) Filed: Jun. 15, 2010

(51) Int. Cl. B32B 3/06; D05B 3/12; B23P 11/00

(52) U.S. Cl. 428/102; 29/525.01; 112/475.14

(57) ABSTRACT

A system and method to weight a recreational ground covering comprising a top layer and a bottom layer stitched together along at least one edge and leaving at least one edge open. Along each open edge is a connection system, such as Velcro®, snaps, or buttons, which connects the open edge of the top and bottom layers. Such arrangement creates a “pocket” system such that may be filled with sand, rocks, or any other available objects or substance that may be found naturally without requiring additional equipment or other means to weight or stabilize the covering once it is spread on the ground.

### BACKGROUND OF THE INVENTION

1. Field of the Technology

This invention relates, generally, to the field of weighting and stabilizing outdoor coverings such as beach blankets, beach towels, tents, picnic blankets, and all other related articles, and more specifically to such articles with a built-in weighting and stabilization system to prevent movement and hold them in place.

2. Background

Conventional beach blankets or towels, picnic blankets, and all other such articles are generally constructed to be spread on the ground to allow a person or persons to sit, lay, converse, and enjoy an outdoor environment without direct contact with the ground. Such articles also serve the needs of cleanliness by preventing direct contact with the elements and is a desired attribute if serving food or sleeping.

A common and unavoidable problem with these conventional articles is wind, which is unpredictable and ubiquitous. Although the user serves as a weight to prevent the article from flying away, it is oftentimes necessary to find other objects to weight the edges or corners of the articles down to prevent them from blowing around the person or persons using the article. Not only can wind make the article difficult and frustrating to use while it is occupied, should the person or persons decide to walk away or stand or not occupy the entire article, it may blow away.

Many of these conventional articles have incorporated means to anchor the article or in some other way to hold it to the ground. Some examples are having weights sewn into the corners or edges of the article and/or having eye openings with grommets through with the user could put a stake into the ground, such as with a tent, or tie it to another object. These conventional solutions are problematic because they add weight to the individual articles or require extra equipment or accessories to anchor the article to the ground. These conventional solutions, therefore, make the article more cumbersome to both transport and to use.

It would be advantageous, therefore, to have an outdoor covering article that has its own incorporated weighting and stabilizing system. It would be further advantageous for such a system to be customizable based on the type of ground it is used on. Such an article and system would be lightweight and not require additional equipment or using other items to weight the article down. The article would be completely self-weighting and easy and uncomplicated to use.

The invention, described in more detail below, provides an improvement over conventional outdoor coverings. The invention described by the embodiments below not only provides a self-weighting and stabilization system, but also obviates the need for additional equipment or cumbersome items to hold the article in place. The embodiments and the invention described, below have a wide range of usage and may be applied to multiple articles. The absence of description of a specific article should not be taken to exclude it from protection.

### SUMMARY

In accordance with the present invention, the present invention provides a lightweight weighting system incorporated into a recreational ground covering that is portable and makes use of naturally occurring objects.

A preferred embodiment of the system of the invention comprises a ground covering comprising a top fabric layer; a bottom fabric layer; a seam stitching at least one edge of said bottom layer and said top layer together; and a connection system joining at least one unstitched edge of said bottom layer with at least one unstitched edge of said top layer.

A preferred embodiment of the system of the invention further comprises a Velcro®-type connection system and wherein said top layer and said bottom layer each contains a component of said Velcro®-type connection system.

A preferred embodiment of the system of the invention further comprises a button connection system comprising a button and a buttonhole, wherein said button is disposed on either said top layer or said bottom layer and said buttonhole is disposed opposite the button on the corresponding said top or said bottom layer.

A preferred embodiment of the system of the invention further comprises a snap system comprising a male component and a female component, wherein said male component of said snap system is disposed on either said top layer and said female component of said snap system is disposed opposite the male component on the corresponding said top or said bottom layer.

A preferred embodiment of the system of the invention further comprises at least one eye encircled by a grommet is disposed along said unstitched edge of said top layer and disposed at an opposite point along said unstitched edge of said bottom layer.

A preferred embodiment of the system of the invention further comprises a fastener.

A preferred embodiment of the system of the invention further comprises a fastener comprised of a carabiner-type clip.

A preferred embodiment of the system of the invention further comprises a fastener comprised of a bungee hook.

A preferred embodiment of the system of the invention further comprises a fastener comprised of a buckle and straps.

A further embodiment of the present invention comprises a method for weighting a ground covering comprising providing a top fabric layer; providing a bottom fabric layer; providing a seam stitching at least one edge of said bottom layer and said top layer together; and providing a connection system joining at least one unstitched edge of said bottom layer with at least one unstitched edge of said top layer.

A preferred embodiment of the method of the invention further comprises a Velcro®-type connection system and wherein said top layer and said bottom layer each contains a component of said Velcro®-type connection system.

A preferred embodiment of the method of the invention further comprises a button connection system comprising a button and a buttonhole, wherein said button is disposed on either said top layer or said bottom layer and said buttonhole is disposed opposite the button on the corresponding said top or said bottom layer.

A preferred embodiment of the method of the invention further comprises a snap system comprising a male component and a female component, wherein said male component of said snap system is disposed on either said top layer and said female component of said snap system is disposed opposite the male component on the corresponding said top or said bottom layer.

A preferred embodiment of the method of the invention further comprises at least one eye encircled by a grommet is disposed along said unstitched edge of said top layer and disposed at an opposite point along said unstitched edge of said bottom layer.

A preferred embodiment of the method of the invention further comprises comprising a fastener.

A preferred embodiment of the method of the invention further comprises a fastener comprised of a carabiner-type clip.

A preferred embodiment of the method of the invention further comprises a fastener comprised of a bungee hook.

A preferred embodiment of the method of the invention further comprises a fastener comprised of a buckle and straps.

### BRIEF DESCRIPTION OF THE DRAWINGS

FIG. 1 shows a top perspective view of an exemplary embodiment of the present invention with the weighting system provided around the entire edge.

FIG. 2 shows a cut-away top perspective of a corner of the present invention with the weighting system provided around the entire edge.

FIG. 3 shows a cut-away, front perspective view of the weighting system of an exemplary embodiment of the present invention with the weighting system provided around the entire edge.

FIG. 4 shows a top perspective of an embodiment of the invention with the weighting system provided at the corners of the article and along one or more side edges.

FIG. 5 shows a top perspective of an embodiment of the invention with the weighting system disposed across the width of the article at intervals along its length.

FIG. 6 shows a top perspective view of an embodiment of the invention as a stand-alone pocket with means to attach it to other objects to weight them down.

### DETAILED DESCRIPTION OF EXEMPLARY EMBODIMENTS

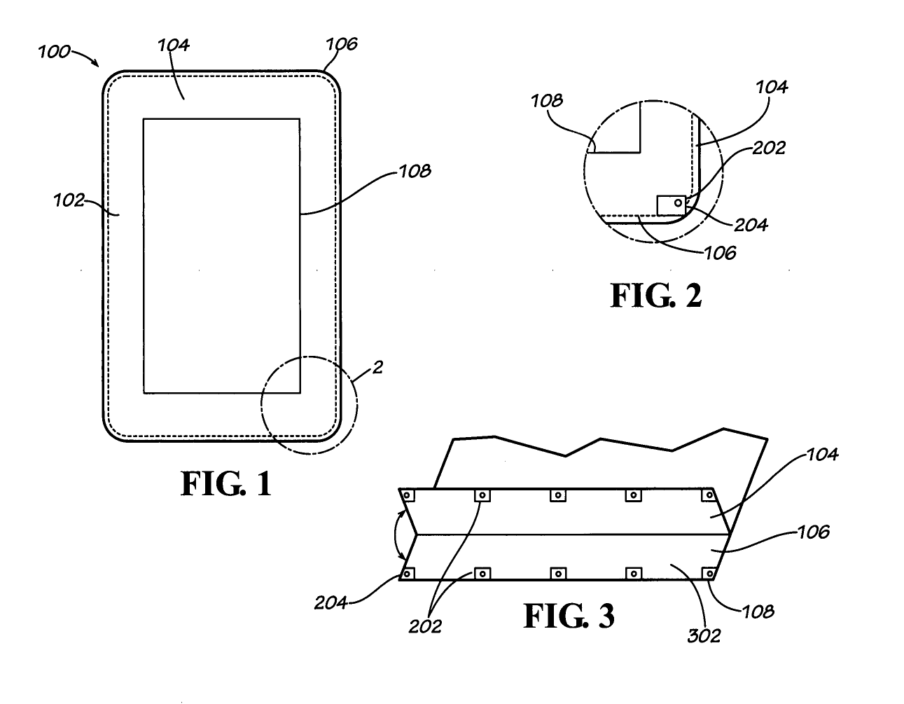

Turning now to the drawings, FIG. 1 is a top perspective view of an exemplary embodiment of the present invention, which is a rectangular beach blanket 100. For the purposes of this disclosure, an exemplary beach blanket is used, but it will be understood by one of ordinary skill in the art the invention may be a beach towel, a beach blanket, a picnic blanket, the floor of a tent, or any other such article meant to be laid on the ground to separate a person or persons from direct contact with the ground. Disclosed is an envelope or pocket 102 that runs the entire perimeter of the beach blanket 100. The pocket is created by providing a top layer 104 of fabric, such as terrycloth or other soft, non-abrasive fabric that would be commonly used for a towel or blanket or other recreational outdoor covering, and a second, bottom layer 106 that may be canvas, plastic, or any other pliable, lightweight material suitable for outdoor use, such as that used for a tarpaulin. At a fixed measurement from the outer edge, the top and bottom layers are sewn together, creating an inner seam 108 that runs parallel to the entire perimeter, equidistant from the edge of the beach blanket 100. The pocket 102 is then created between the top 104 and bottom 106 layers and bounded by the interior seam 108.

Turning to the perspective of a corner of the beach blanket 100 shown in FIG. 2, the inner seam 108 is shown more clearly. In this embodiment, the top layer 104 may overlap the bottom layer 106, which provides a more aesthetically pleasing appearance. Additionally shown in FIG. 2 is a Velcro®-type connector 202 with the “hooks” side disposed upon either the top 104 or bottom 106 layer and the “loops” side disposed upon the opposite, corresponding layer. It will be understood by one of ordinary skill in the art that any connector of the type for which Velcro® is the name brand may be used and that either the “hooks” or “loops” side may be used on either the top 104 or bottom 106 layer with no change in functionality. It will also be understood by one of ordinary skill in the art that a Velcro®-type connector is one of many types of connectors that could be used to hold the two layers together. Other types of connectors such as buttons, snaps, or any other type of fabric connector may be used so long as they may connect the top 104 and bottom 106 layers together. FIG. 2 also shows that the exemplary embodiment may contain an eye and grommet option 204 so a user may secure it with stakes or rope if available.

Describing in more detail the functioning of the pocket 102, the user first spreads the beach blanket 100 on the ground. In this exemplary case, it may be assumed that the ground is that of a beach, and, therefore, composed of sand. The user may then flip the top layer 104 over to “open” the pocket 102. The benefit of this exemplary embodiment of the invention is that it uses the ground and naturally occurring materials to weight down the beach blanket 100. Once the pocket 102 is “open,” the user may then take sand 302 from the beach and place it directly on the bottom layer 106. In this exemplary embodiment, the sand 302 would be added in the entire pocket 102, which follows the entire perimeter of the beach blanket 100. The user would then fold the top layer 104 back over the sand 302 and connect the Velcro® or other connectors 202.

FIG. 3 shows a more detailed perspective with the top layer 104 open and sand 302 covering the bottom layer 108. Additionally, FIG. 3 shows additional Velcro®-type connectors 202 spaced along the edge of the beach blanket 100 as well as the eye and grommet 204, which may be disposed at intervals along the edge:

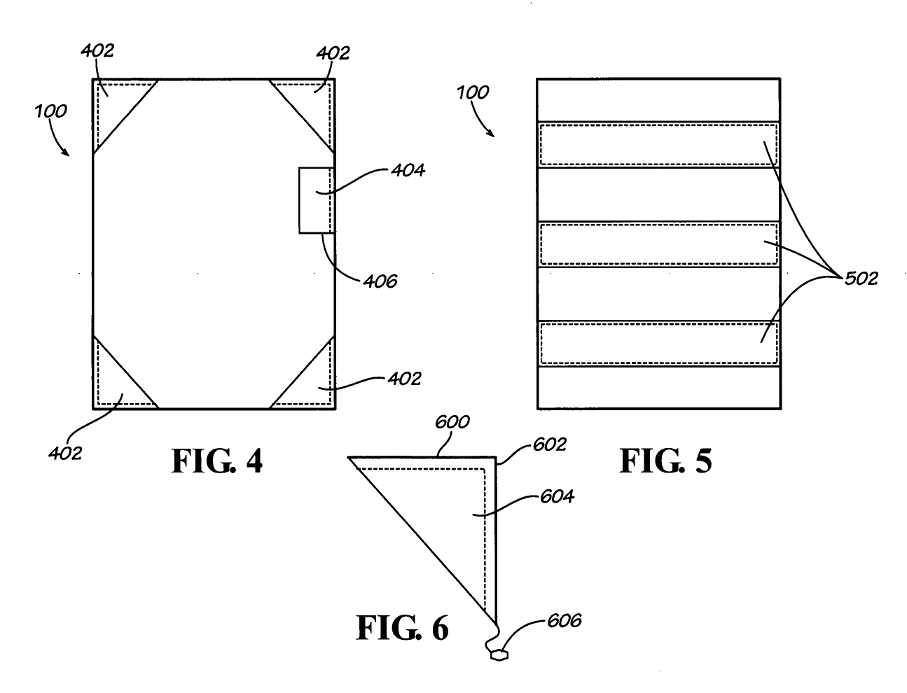

FIG. 4 shows another exemplary embodiment in which the pockets 402 containing the weighting sand 304 are disposed at each of the four corners, not around the entire perimeter. It will be appreciated by one of ordinary skill in the art that, in addition to the corners, additional pockets 404 may be provided and spaced along the perimeter of the beach blanket 100 as needed. Such a side pocket 404 would differ from the other pockets 402 because the seam 406 would completely encompass the pocket, allowing it to be filled with sand as one would a sandbag.

FIG. 5 is an additional exemplary embodiment of the present invention, showing pockets 502 that run the entire width or length of the beach blanket 100 such that each may be filled similarly to a sandbag.

FIG. 6 is another exemplary embodiment of the present invention, providing an after-market weighting system for outdoor items consisting of a single pocket 600 with top 602 and bottom 604 layers sewn together. Attached to the pocket 600 is a fastener such as a carbiner, bungee clip, buckle and straps, or any other fastener suitable for outdoor use by which the pocket 600 may be attached to a chair, umbrella, bag, or any other object which may blow away in the wind. It is compact and lightweight and, like the other embodiments, may simply be emptied when no longer needed.

In view of the foregoing, it will be appreciated that an embodiment of the present invention provides a lightweight and highly portable weighting system for recreational outdoor coverings because such a system is incorporated into the covering itself. Such covering, as will be understood by those of ordinary skill in the art, may be a beach blanket, a beach towel, a picnic blanket, a tent base, or any other covering or other article that is intended to be used outdoors. It will also be appreciated by one of ordinary skill in the art that any of the above embodiments may be used in any of the described configurations or any combination, thereof. For example, any of the embodiments may have Velcro®-type, buttons, or snap fasteners to hold the bottom and top layers of the weighting pocket together, or some combination thereof. Any of the embodiments may or may not have the eye and grommet option for securing the embodiment of the invention as well. It will be further understood by one of ordinary skill in the art that sand is not required as the weighting substance. Any naturally found articles such as dirt, sand, rocks, or any other objects or substance available to the user may be used in the pocket to weight the embodiment of the invention.

An exemplary embodiment of the present invention addresses the multiple needs for providing a lightweight, portable, and easily used weighting and stabilizing system for outdoor ground coverings. The invention solves the problem of requiring additional equipment or articles to be used to weight down a ground covering.

What is claimed is:

1. A system for weighting a ground covering comprising:
a top fabric layer;
a bottom fabric layer;
a seam stitching at least one edge of said bottom layer and at least one edge of said top layer together; and
a connection system joining at least one unstitched edge of said bottom layer with at least one unstitched edge of said top layer.

2. The system for weighting a ground covering of claim 1, wherein said connection system is a Velcro®-type connection system and wherein said top layer and said bottom layer each contains a component of said Velcro®-type connection system.

3. The system for weighting a ground covering of claim 1, wherein said connection system is a button system comprising a button and a buttonhole, wherein said button is disposed on either said top layer or said bottom layer and said buttonhole is disposed opposite the button on the corresponding said top or said bottom layer.

4. The system for weighting a ground covering of claim 1, wherein said connection system is a snap system comprising a male component and a female component, wherein said male component of said snap system is disposed on either said top layer and said female component of said snap system is disposed opposite the male component on the corresponding said top or said bottom layer.

5. The system for weighting a ground covering of claim 1, wherein at least one eye encircled by a grommet is disposed along said unstitched edge of said top layer and disposed at an opposite point along said unstitched edge of said bottom layer.

6. The system for weighting a ground covering of claim 1, further comprising a fastener.

7. The system for weighting a ground covering of claim 6, wherein the fastener is comprised of a carabiner-type clip.

8. The system for weighting a ground covering of claim 6, wherein the fastener is comprised of a bungee hook.

9. The system for weighting a ground covering of claim 6, wherein the fastener is comprised of a buckle and straps.

10. A method for weighting a ground covering comprising:
providing a top fabric layer;
providing a bottom fabric layer;
providing a seam stitching at least one edge of said bottom layer and at least one edge of said top layer together; and
providing a connection system joining at least one unstitched edge of said bottom layer with at least one unstitched edge of said top layer.

11. The method for weighting a ground covering of claim 1, wherein said connection system is a Velcro®-type connection system and wherein said top layer and said bottom layer each contains a component of said Velcro®-type connection system.

12. The method for weighting a ground covering of claim 1, wherein said connection system is a button system comprising a button and a buttonhole, wherein said button is disposed on either said top layer or said bottom layer and said buttonhole is disposed opposite the button on the corresponding said top or said bottom layer.

13. The method for weighting a ground covering of claim 1, wherein said connection system is a snap system comprising a male component and a female component, wherein said male component of said snap system is disposed on either said top layer and said female component of said snap system is disposed opposite the male component on the corresponding said top or said bottom layer.

14. The method for weighting a ground covering of claim 1, wherein at least one eye encircled by a grommet is disposed along said unstitched edge of said top layer and disposed at an opposite point along said unstitched edge of said bottom layer.

15. The method for weighting a ground covering of claim 1, further comprising a fastener.

16. The method for weighting a ground covering of claim 15, wherein the fastener is comprised of a carabiner-type clip.

17. The method for weighting a ground covering of claim 15, wherein the fastener is comprised of a bungee hook.

18. The method for weighting a ground covering of claim 15, wherein the fastener is comprised of a buckle and straps.
